(19) United States
(12) Patent Application Publication
(10) Pub. No.: US 2025/0253871 A1
(43) Pub. Date: Aug. 7, 2025

(54) APPARATUS FOR PROCESSING RADIO FREQUENCY SIGNALS

(71) Applicant: Nokia Solutions and Networks Oy, Espoo (FI)

(72) Inventors: Dirk WIEGNER, Stuttgart (DE); Andreas WICH, Ulm (DE)

(21) Appl. No.: 18/857,496

(22) PCT Filed: Apr. 21, 2022
(86) PCT No.: PCT/EP2022/060519

§ 371 Date: Oct. 17, 2024

(51) Int. Cl. H04B 1/00; H04B 1/44

(52) U.S. Cl. CPC H04B 1/0057; H04B 1/44

(57) ABSTRACT

An apparatus for processing radio frequency signals, comprising a primary signal processing stage that is configured to process multiband radio frequency signals comprising at least a first frequency band and a second frequency band, a first signal path, and a second signal path, wherein the apparatus is configured to selectively couple the primary signal processing stage a) with the first signal path to enable processing of multiband radio frequency signals associated with the first signal path using the primary signal processing stage and/or b) with the second signal path to enable processing of multiband radio frequency signals associated with the second signal path using the primary signal processing stage.

### FIELD OF THE DISCLOSURE

Various example embodiments relate to an apparatus for processing radio frequency signals.

Further embodiments relate to a method of processing radio frequency signals.

### BACKGROUND

Apparatus for processing radio frequency, RF, signals may e.g. be used in transceiver devices, e.g. for wireless communication systems.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to an apparatus for processing radio frequency signals, comprising a primary signal processing stage that is configured to process multiband radio frequency signals comprising at least a first frequency band and a second frequency band, a first signal path, and a second signal path, wherein the apparatus is configured to selectively couple the primary signal processing stage a) with the first signal path to enable processing of multiband radio frequency signals associated with the first signal path using the primary signal processing stage and/or b) with the second signal path to enable processing of multiband radio frequency signals associated with the second signal path using the primary signal processing stage. In some embodiments, the primary signal processing stage may be flexibly used to process one or more multiband radio frequency signals, for example in a time division duplexed, TDD, manner.

In some embodiments, the first frequency band and the second frequency band are non-contiguous, i.e. have a non-vanishing frequency spacing between each other. In some embodiments, the frequency spacing may e.g. comprise 10 MHz or more. In some embodiments, the frequency spacing may e.g. comprise 100 MHz or more, e.g. depending on a processing bandwidth of the primary signal processing stage.

In some embodiments, the multiband radio frequency signals comprise more than two frequency bands, e.g. three or more frequency bands, wherein at least two of the three or more frequency bands may e.g. be non-contiguous.

In some embodiments, the primary signal processing stage comprises a signal processing chain comprising at least one signal processing element capable of processing the multiband radio frequency signals (e.g., having a bandwidth covering at least the first frequency band and the second frequency band (as well as an optional frequency spacing between the first frequency band and the second frequency band), a first switch and a second switch, wherein the first switch is configured to selectively couple a first input of the primary signal processing stage or a second input of the primary signal processing stage to an input of the signal processing chain, wherein the second switch is configured to selectively couple an output of the signal processing chain to a first output of the primary signal processing stage or to a second output of the primary signal processing stage. In some embodiments, this way, several different signal paths may be established, e.g. the abovementioned first signal path and the second signal path.

In some embodiments, the at least one signal processing element comprises at least one of a) an amplifier, b) an attenuator, c) a bias control device for applying a predetermined bias to at least one amplifier.

In some embodiments, the amplifier may e.g. be a low noise amplifier, LNA, and/or a preamplifier and/or gain block and/or a variable gain amplifier.

In some embodiments, the attenuator may e.g. be a controllable attenuator.

In some embodiments, the bias control device may e.g. be configured to apply a bias to at least one amplifier, e.g. based on at least one signal processed by the apparatus.

In some embodiments, the apparatus comprises a frequency band separator configured to receive an output signal of the primary signal processing stage comprising a first output signal portion associated with the first frequency band and a second output signal portion associated with the second frequency band, to provide the first output signal portion to a first secondary signal processing stage, and to provide the second output signal portion to a second secondary signal processing stage.

In some embodiments, the secondary signal processing stages may e.g. be configured to process a single one of the various frequency bands, thus e.g. comprising a smaller bandwidth than the primary signal processing stage and/or its components. In some embodiments, this enables to optimize signal processing within the secondary signal processing stage for one specific frequency band of the multiple frequency bands.

In some embodiments, the frequency band separator comprises a first impedance transformer associated with a wavelength of the second frequency band, e.g. comprising an electrical length of lambda-2/4, wherein lambda-2 characterizes a wavelength associated with a frequency (e.g., center frequency) of the second frequency band, and a second impedance transformer associated with a wavelength of the first frequency band, e.g. comprising an electrical length of lambda-1/4, wherein lambda-1 characterizes a wavelength associated with a frequency (e.g., center frequency) of the first frequency band. In some embodiments, this enables to separate frequency bands from each other and to selectively provide respective single frequency bands, e.g. to subsequent secondary signal processing stages.

In some embodiments, at least one of the first secondary signal processing stage and the second secondary signal processing stage comprises at least one frequency band-specific amplifier, for example power amplifier, configured to amplify a signal associated with the first frequency band or the second frequency band.

In some embodiments, an optional bias circuit may be provided for the frequency band-specific amplifier.

In some embodiments, at least one of the first secondary signal processing stage and the second secondary signal processing stage comprises a bypass for selectively bypassing the at least one frequency band-specific amplifier. In some embodiments, this way, e.g. a power amplification may selectively be activated or deactivated, e.g. related to actual load scenario and/or requirements. In some embodiments, e.g. if a power amplification is deactivated, the respective power amplifier may be turned off, e.g. to reduce power consumption and/or to improve an overall energy efficiency.

In some embodiments, the apparatus is configured to, for example dynamically (e.g., during operation), adapt a bias for at least one amplifier, e.g. using at least one optional bias circuit. In some embodiments, the bias adaptation may e.g. be performed based on at least one of: a) a direction of a signal flow, e.g. transmit or receive mode, e.g. uplink or downlink mode, b) a number of (e.g., currently) active frequency bands, c) a load situation.

In some embodiments, at least one of the first secondary signal processing stage and the second secondary signal processing stage comprises a first switch and a second switch, the first and second switches configured to selectively couple the at least one frequency band-specific amplifier or the bypass to an input and an output of the at least one of the first secondary signal processing stage and the second secondary signal processing stage, thus e.g. controlling whether amplification using the frequency band-specific amplifier is effected or whether an input signal to the secondary signal processing stage is bypassed with respect to, e.g. not amplified by, the frequency band-specific amplifier.

In some embodiments, at least one of the first secondary signal processing stage and the second secondary signal processing stage comprises a third switch configured to selectively couple a) a first port of the at least one of the first secondary signal processing stage and the second secondary signal processing stage with a second port of the at least one of the first secondary signal processing stage and the second secondary signal processing stage or b) the second port of the at least one of the first secondary signal processing stage and the second secondary signal processing stage with a third port of the at least one of the first secondary signal processing stage and the second secondary signal processing stage. In some embodiments, this way, different signal paths with respect to the secondary signal processing stages may be defined.

In some embodiments, the apparatus further comprising at least one circulator configured to perform at least one of: a) providing a signal processed by at least one of the first secondary signal processing stage and the second secondary signal processing stage to at least one antenna, b) providing a signal received from at least one antenna to the primary signal processing stage.

In some embodiments, the at least one circulator may e.g. be integrated in at least one secondary signal processing stage.

In some embodiments, the at least one circulator may e.g. be arranged outside of the at least one secondary signal processing stage.

In some embodiments, the at least one circulator may e.g. be used to provide a signal received from at least one antenna to the second input of the primary signal processing stage, e.g. for processing the signal received from at least one antenna using the primary signal processing stage.

In some embodiments, the apparatus comprises at least one combiner for combining a first signal associated with the first frequency band and a second signal associated with the second frequency band to a multiband signal. In some embodiments, the at least one combiner may e.g. be used to combine different signals associated with different frequency bands, e.g. received from one or more antennas, e.g. to form a multiband signal, e.g. for processing of the so formed multiband signal, e.g. by the primary signal processing stage.

In some embodiments, the apparatus comprises at least one filter for filtering at least one signal associated with a single one of the first frequency band the second frequency band, e.g. at least one band-pass filter associated with the respective frequency band.

In some embodiments, the at least one filter, e.g. band-pass filter, may e.g. be provided within at least one of the secondary signal processing stages.

In some embodiments, the at least one filter, e.g. band-pass filter, may e.g. be provided outside of at least one of the secondary signal processing stages.

In some embodiments, the apparatus comprises at least one phase shifter for modifying a phase of at least one signal associated with the apparatus.

In some embodiments, the at least one phase shifter may e.g. be provided in the primary signal processing stage.

In some embodiments, the at least one phase shifter may e.g. be provided in at least one of the secondary signal processing stages.

In some embodiments, the at least one phase shifter may e.g. be provided for at least one individual frequency band and/or antenna element.

In some embodiments, the apparatus is configured to: receive a first signal at the first input of the primary signal processing stage, provide the first signal via the first switch to the input of the signal processing chain, process the first signal by means of the signal processing chain, provide a processed first signal via the second switch either a) to the first output of the primary signal processing stage (thus e.g. defining a first mode of operation, e.g. associated with a transmit direction) or b) to the second output of the primary signal processing stage (thus e.g. defining a second mode of operation, e.g. a feedback mode, which e.g. enables to perform an analysis, e.g. of signal distortion as imparted on a signal processed by the signal processing chain). In some embodiments, the feedback mode may e.g. be used to apply a predistortion to a signal to be processed by the signal processing chain.

In some embodiments, the second mode or feedback mode may e.g. be used to linearize or optimize a performance of the primary signal processing stage. In some embodiments, e.g. in case of a multi-antenna system or other systems e.g. having more than one primary signal processing stage, some antenna elements/paths may be turned off or may be used for the feedback mode, e.g. for test measurements (e.g., self-test, performance optimization, sub-unit calibration), while some other antenna elements/paths may be used (e.g., simultaneously), e.g. for data transmission and/or reception. In some embodiments, the apparatus is configured to: receive a second signal at the second input of the primary signal processing stage, provide the second signal via the first switch to the input of the signal processing chain, process the second signal by means of the signal processing chain, provide a processed second signal via the second switch to the second output of the primary signal processing stage, (thus e.g. defining a third mode of operation, e.g. associated with a receive direction).

Further exemplary embodiments relate to a transceiver (TRX) device comprising at least one apparatus according to the embodiments.

In some embodiments, the transceiver device may comprise a signal source providing at least one multiband RF signal comprising at least the first frequency band and the second frequency band, e.g. for processing by the apparatus according to the embodiments, e.g. in a transmit direction.

In some embodiments, the transceiver device may comprise a signal sink receiving at least one multiband RF signal processed by the apparatus according to the embodiments, e.g. in a receive direction.

In some embodiments, the transceiver device may comprise at least one antenna or antenna system, the antenna system e.g. comprising multiple antenna elements.

Further exemplary embodiments relate to a device for a wireless communications network, e.g. according to the 5G and/or 6G type or of other types, comprising at least one apparatus according to the embodiments.

In some embodiments, the device may e.g. be a network device, e.g. base station, e.g. gNB, for a cellular communications network.

In some embodiments, the device may e.g. be a terminal device, e.g. user equipment, for a cellular communications network, or an IoT (Internet-of-Things) device.

Further exemplary embodiments relate to a wireless communication system, e.g. network, comprising at least one device according to the embodiments.

Further exemplary embodiments relate to a method of processing radio frequency signals associated with an apparatus, the apparatus comprising a primary signal processing stage that is configured to process multiband radio frequency signals comprising at least a first frequency band and a second frequency band, a first signal path, and a second signal path, wherein the method comprises: selectively coupling the primary signal processing stage a) with the first signal path to enable processing of multiband radio frequency signals associated with the first signal path using the primary signal processing stage and/or b) with the second signal path to enable processing of multiband radio frequency signals associated with the second signal path using the primary signal processing stage.

Further embodiments relate to a computer program or computer program product comprising instructions which, when the program is executed by a computer, cause the computer to carry out the method according to the embodiments.

Further embodiments relate to an apparatus for processing radio frequency signals, the apparatus comprising means for processing multiband radio frequency signals comprising at least a first frequency band and a second frequency band, a first signal path, and a second signal path, wherein the apparatus further comprises: means for selectively coupling a primary signal processing stage configured to process the multiband radio frequency signals a) with the first signal path to enable processing of multiband radio frequency signals associated with the first signal path using the primary signal processing stage and/or b) with the second signal path to enable processing of multiband radio frequency signals associated with the second signal path using the primary signal processing stage.

### BRIEF DESCRIPTION OF THE FIGURES

FIG. 1 schematically depicts a simplified block diagram according to some embodiments,

FIG. 2 schematically depicts a simplified flow chart according to some embodiments,

FIG. 3A schematically depicts a simplified block diagram according to some embodiments,

FIG. 3B schematically depicts a simplified block diagram according to some embodiments,

FIG. 4 schematically depicts a simplified block diagram according to some embodiments,

FIG. 5 schematically depicts a simplified block diagram according to some embodiments,

FIG. 6A schematically depicts frequency bands according to some embodiments,

FIG. 6B schematically depicts frequency bands according to some embodiments,

FIG. 6C schematically depicts frequency bands according to some embodiments,

FIG. 7 schematically depicts a simplified flow chart according to some embodiments,

FIG. 8 schematically depicts a simplified flow chart according to some embodiments,

FIG. 9A schematically depicts a simplified block diagram according to some embodiments,

FIG. 9B schematically depicts a simplified block diagram according to some embodiments,

FIG. 9C schematically depicts a simplified block diagram according to some embodiments,

FIG. 9D schematically depicts a simplified block diagram according to some embodiments,

FIG. 9E schematically depicts a simplified block diagram according to some embodiments,

FIG. 10 schematically depicts a simplified flow chart according to some embodiments,

FIG. 11 schematically depicts a simplified flow chart according to some embodiments,

FIG. 12 schematically depicts a simplified block diagram according to some embodiments,

FIG. 13 schematically depicts a simplified block diagram according to some embodiments,

FIG. 14 schematically depicts a simplified block diagram according to some embodiments,

FIG. 15 schematically depicts a simplified block diagram according to some embodiments,

FIG. 16 schematically depicts a simplified block diagram according to some embodiments,

FIG. 17 schematically depicts a simplified block diagram according to some embodiments,

FIG. 18 schematically depicts a simplified flow-chart according to some embodiments,

FIG. 19 schematically depicts a simplified block diagram according to some embodiments.

### DESCRIPTION OF SOME EXEMPLARY EMBODIMENTS

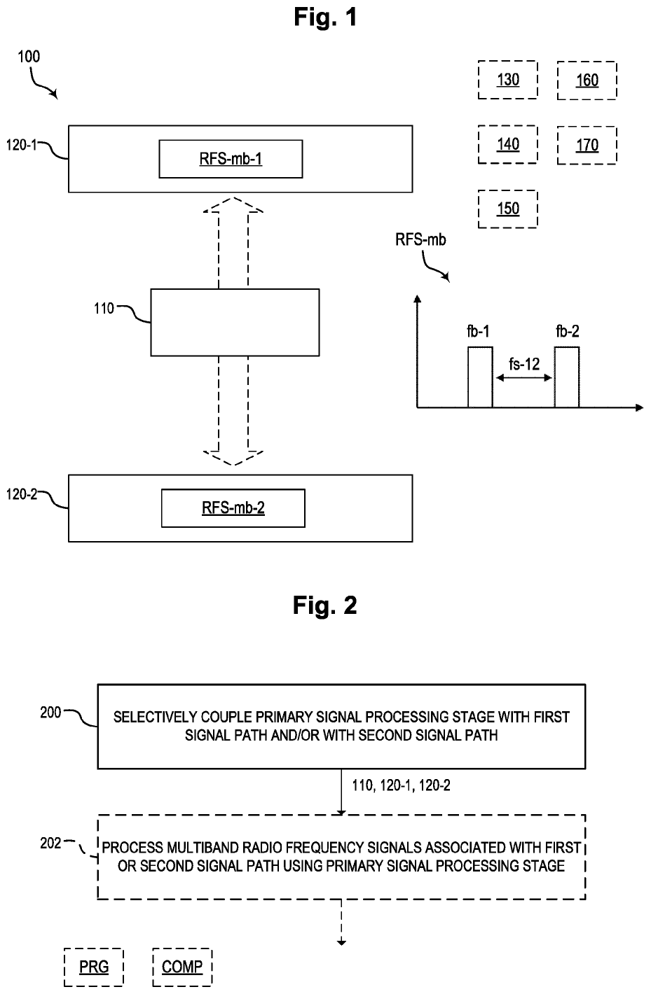

Some embodiments, see FIG. 1, relate to an apparatus 100 for processing radio frequency signals, comprising a primary signal processing stage 110 that is configured to process multiband radio frequency signals RFS-mb comprising at least a first frequency band fb-1 and a second frequency band fb-2, a first signal path 120-1, and a second signal path 120-2, wherein the apparatus 100 is configured to selectively couple, see also block 200 of FIG. 2, the primary signal processing stage 110 a) with the first signal path 120-1 to enable processing of multiband radio frequency signals RFS-nb-1 associated with the first signal path 120-1 using the primary signal processing stage 110 and/or b) with the second signal path 120-2 to enable processing of multiband radio frequency signals RFS-mb-2 associated with the second signal path 120-2 using the primary signal processing stage 110. In some embodiments, the primary signal processing stage 110 may be flexibly used to process one or more multiband radio frequency signals RFS-mb-1, RFS-mb-2, for example in a time division duplex, TDD, manner, also see block 202 of FIG. 2.

In some embodiments, the first frequency band fb-1 and the second frequency band fb-2 are non-contiguous, i.e. have a non-vanishing frequency spacing fs-12 (FIG. 1) between each other. In some embodiments, the frequency spacing fs-12 may e.g. comprise 10 MHz or more. In some embodiments, the frequency spacing may e.g. comprise 100 MHz or more, e.g. depending on a processing bandwidth of the primary signal processing stage 110.

In some embodiments, the multiband radio frequency signals RFS-mb comprise more than two frequency bands (not shown), e.g. three or more frequency bands, wherein at least two of the three or more frequency bands may e.g. be non-contiguous.

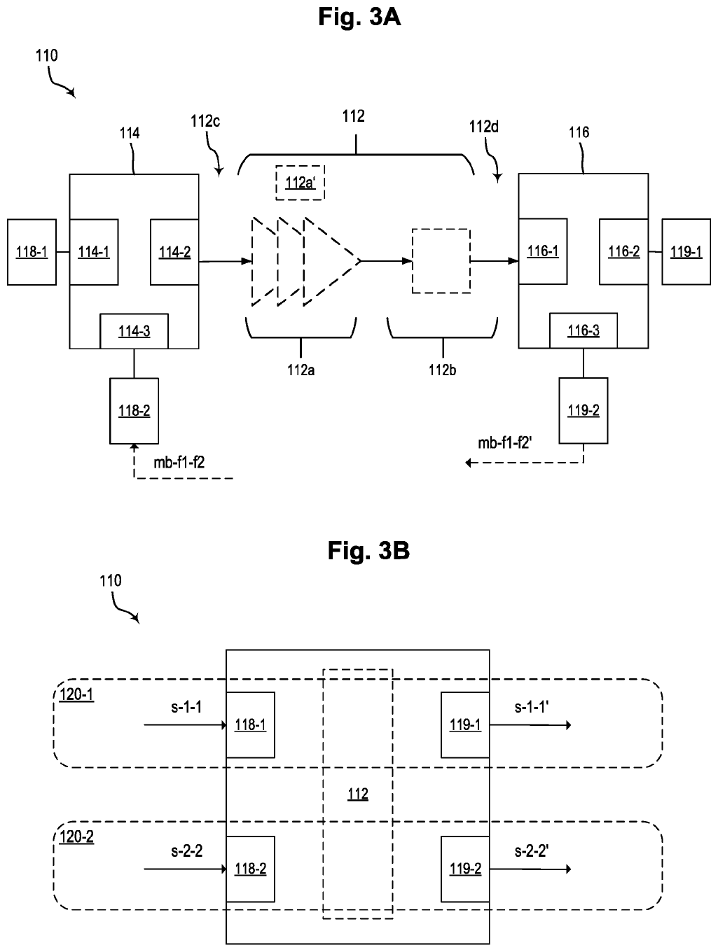

In some embodiments, FIG. 3A, the primary signal processing stage 110 comprises a signal processing chain 112 comprising at least one signal processing element 112a, 112b, 112a′ capable of processing the multiband radio frequency signals RFS-mb (e.g., having a bandwidth covering at least the first frequency band fb-1 and the second frequency band fb-2 (as well as an optional frequency spacing fs-12 between the first frequency band fb-1 and the second frequency band fb-2), a first switch 114 and a second switch 116, wherein the first switch 114 is configured to selectively couple a first input 118-1 of the primary signal processing stage 110 or a second input 118-2 of the primary signal processing stage 110 to an input 112c of the signal processing chain 112, wherein the second switch 116 is configured to selectively couple an output 112d of the signal processing chain 112 to a first output 119-1 of the primary signal processing stage 110 or to a second output 119-2 of the primary signal processing stage 110. In some embodiments, this way, several different signal paths, also see FIG. 3B, may be established, e.g. the abovementioned first signal path 120-1 and the second signal path 120-2.

In some embodiments, the first switch 114 comprises a first port 114-1, which is e.g. connected to the first input 118-1 of the primary signal processing stage 110, a second port 114-2, which is connected to the input 112c of the signal processing chain 112, and a third port 114-3, which is connected to the second input 118-2 of the primary signal processing stage 110.

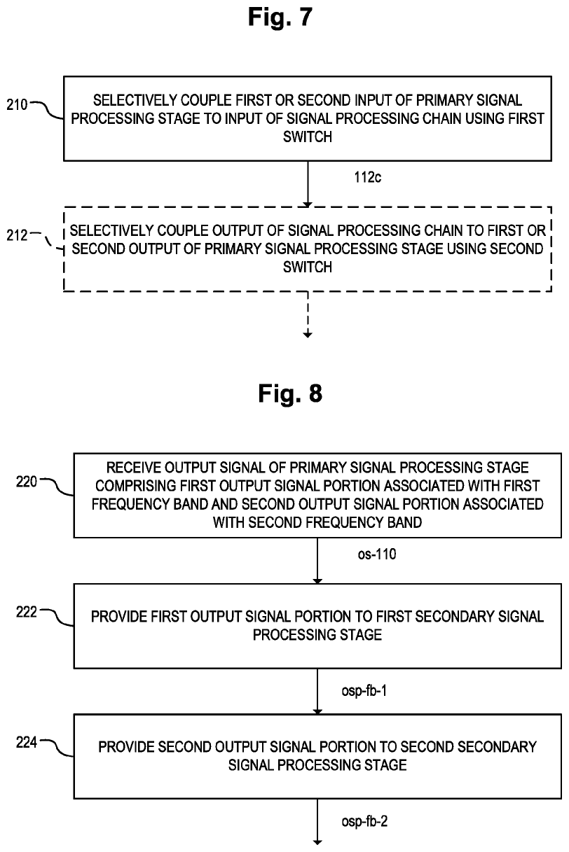

In some embodiments, FIG. 7, the first switch 114 may selectively couple 210 either the first input 118-1 or the second input 118-2 with the input 112c of the signal processing chain 112, thus controlling whether a signal provided at the first input 118-1 or at the second input 118-2 of the primary signal processing stage 110 is to be processed by the signal processing chain 112.

In some embodiments, the second switch 116 (FIG. 3A) comprises a first port 116-1, which is e.g. connected to the output 112d of the signal processing chain 112, a second port 116-2 connected to the first output 119-1 of the primary signal processing stage 110, and a third port 116-3 connected to the second output 119-2 of the primary signal processing stage 110.

In some embodiments, FIG. 7, the second switch 116 may selectively couple 212 either the first output 119-1 or the second output 119-2 with the output 112d of the signal processing chain 112.

FIG. 3B exemplarily depicts two signal paths 120-1, 120-2 as may be attained according to some embodiments.

In some embodiments, the first signal path 120-1 can be attained by controlling the first switch 114 (FIG. 3A) such that it connects the first input 118-1 of the primary signal processing stage 110 with the input 112c of the signal processing chain 112 and by controlling the second switch 116 such that it connects the output 112d of the signal processing chain 112 with the first output 119-1 of the primary signal processing stage 110.

In some embodiments, the second signal path 120-2 can be attained by controlling the first switch 114 (FIG. 3A) such that it connects the second input 118-2 of the primary signal processing stage 110 with the input 112c of the signal processing chain 112 and by controlling the second switch 116 such that it connects the output 112d of the signal processing chain 112 with the second output 119-2 of the primary signal processing stage 110.

In some embodiments, the first signal path 120-1 may e.g. be used for signal processing of RF multiband signals RFS-mb in a first signal processing direction, e.g. a transmit direction.

In some embodiments, the second signal path 120-2 may e.g. be used for signal processing of RF multiband signals RFS-mb in a second signal processing direction, e.g. a receive direction.

Advantageously, in some embodiments, for both processing directions, the same signal processing chain 112 can be used, e.g. in a TDD-multiplexed manner.

In some embodiments, FIG. 3A, the at least one signal processing element 112a, 112b, 112a′ comprises at least one of a) an amplifier 112a, b) an attenuator 112b, c) a bias control device 112a′ for applying a predetermined bias to the at least one amplifier 112a.

In some embodiments, the amplifier 112a may e.g. be a low noise amplifier, LNA, and/or a preamplifier an/or a variable gain amplifier.

In some embodiments, the attenuator 112b may e.g. be a controllable attenuator.

In some embodiments, the bias control device 112a′ may e.g. be configured to a) apply a bias to at least one amplifier 112a, e.g. based on at least one signal processed by the apparatus 100, and/or to b) turn on and/or turn off at least one amplifier 112a, e.g. for energy efficiency.

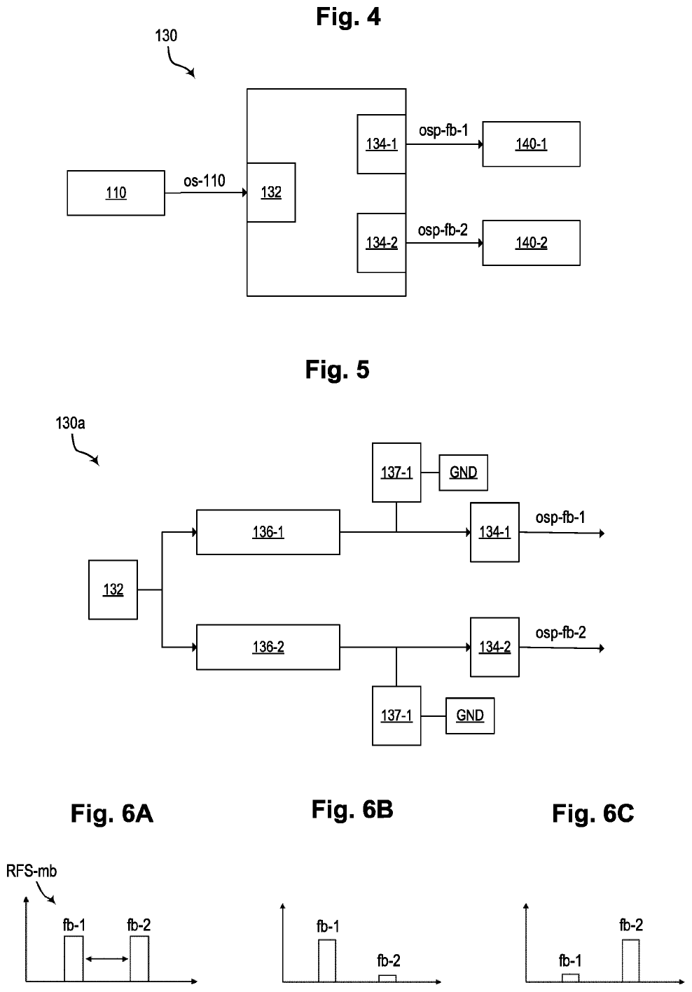

In some embodiments, FIG. 4, the apparatus 100 (FIG. 1) comprises a frequency band separator 130 configured to receive (also see block 220 of FIG. 8) at its input 132 (FIG. 4) an output signal of the primary signal processing stage 110 comprising a first output signal portion osp-fb-1 associated with the first frequency band fb-1 and a second output signal portion osp-fb-2 associated with the second frequency band fb-2, to provide 222 (FIG. 8) the first output signal portion osp-fb-1 to a first secondary signal processing stage 140-1 at a first output 134-1, and to provide 224 (FIG. 8) the second output signal portion osp-fb-2 to a second secondary signal processing stage 140-2 at a second output 134-2. In other words, in some embodiments, the frequency band separator 130 forwards a specific one of the frequency bands provided at its input to a specific output, while suppressing the other frequency bands for the specific output.

In some embodiments, the frequency band separator 130 may be substituted by a splitter, e.g. a 3 dB splitter. However, in contrast to a splitter, the frequency band separator 130 according to the embodiments allows for low loss frequency band/signal separation, and also filtering of the unwanted other frequencies/signals for the individual output signal paths. As an example, contrary to e.g. a 3 dB splitter where ideally 3 dB of power would be lost and no filtering effect of the unwanted signal is achieved, in some embodiments, the frequency band separator 130 may cause—depending on the frequency range—e.g. only about 1 to 1, 5 dB insertion loss and 10 dB or clearly higher unwanted signal suppression.

In some embodiments, the secondary signal processing stages 140-1, 140-2 may e.g. be configured to process a respective single one of the various frequency bands, thus e.g. comprising a smaller bandwidth than the primary signal processing stage 110 and/or its components. In some embodiments, this enables to optimize signal processing within the secondary signal processing stages for one specific frequency band of the multiple frequency bands.

In some embodiments, more than the exemplarily mentioned two secondary signal processing stages 140-1, 140-2 are also possible, e.g., three or more secondary signal processing stages (not shown).

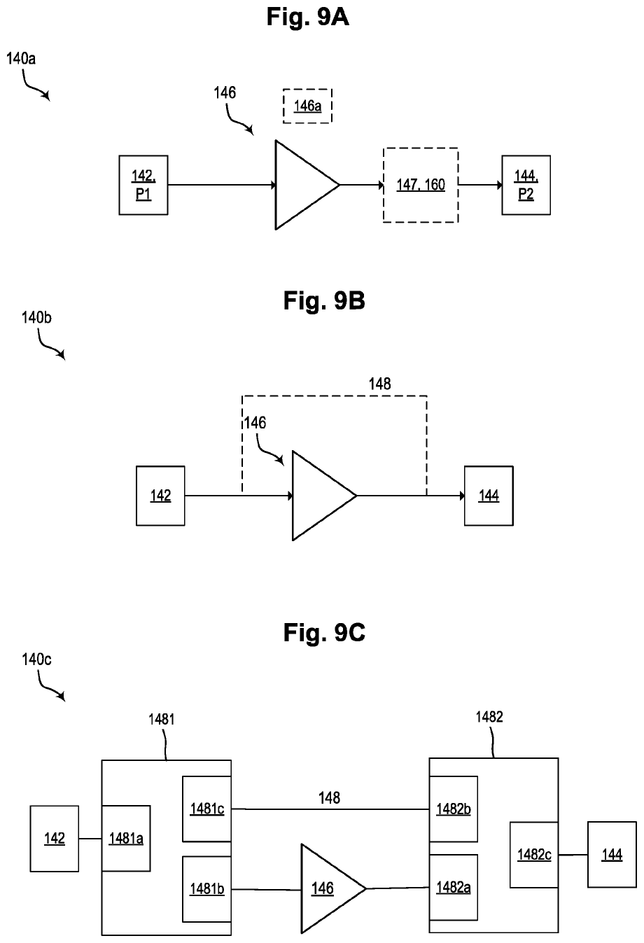

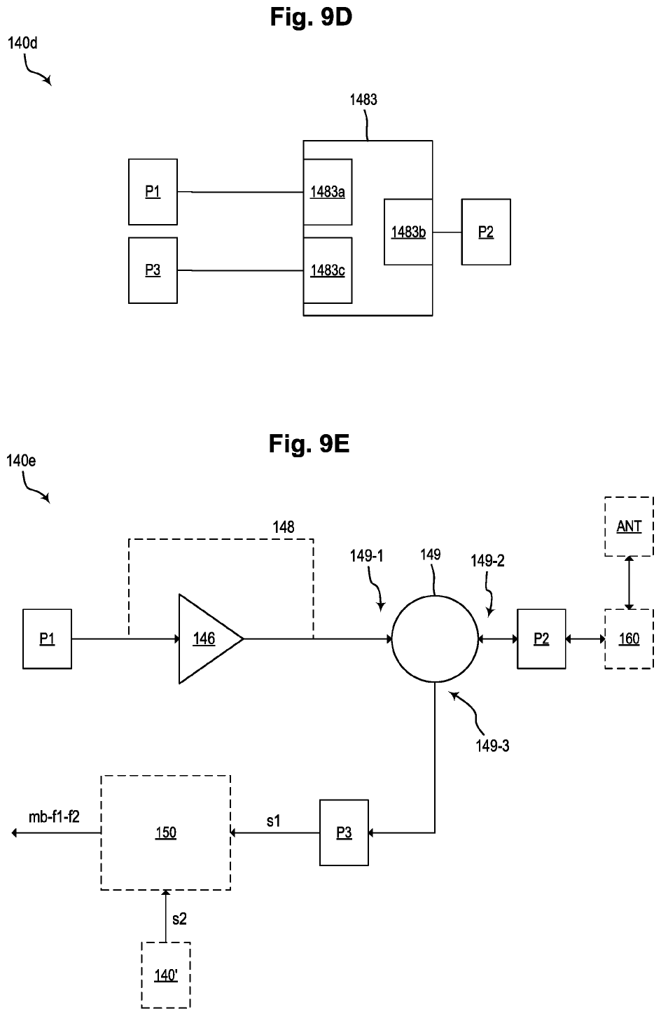

In some embodiments, by this concept, it is possible to operate e.g. one frequency band fb-1 at full load, e.g. with a power amplifier 146 (see FIG. 9A) of a respective first secondary signal processing stage 140-1 active while a further power amplifier of e.g. a second secondary signal processing stage 140-2 may e.g. be deactivated and/or bypassed (see FIG. 9B), and the respective signal is transmitted for low load situation, e.g. enabling to reduce power consumption. In some embodiments, a currently bypassed power amplifier may be turned off, e.g. during the bypassing, to increase energy efficiency.

In some embodiments, see the exemplary configuration 130a of FIG. 5, the frequency band separator comprises a first impedance transformer 136-1 associated with a wavelength of the second frequency band fb-2, e.g. comprising an electrical length of lambda-2/4, wherein lambda-2 characterizes a wavelength associated with a frequency (e.g., center frequency) of the second frequency band fb-2, and a second impedance transformer 136-2 associated with a wavelength of the first frequency band fb-1, e.g. comprising an electrical length of lambda-1/4, wherein lambda-1 characterizes a wavelength associated with a frequency (e.g., center frequency) of the first frequency band fb-1. In some embodiments, this enables to separate the frequency bands fb-1, fb-2 from each other and to selectively provide respective single frequency bands, e.g. to subsequent secondary signal processing stages 140-1, 140-2.

In some embodiments, the operating principle of the frequency band separator 130, 130a may also support more than two frequency bands. In some embodiments, in this case, the frequency band separator 130, 130a may e.g. comprise three or more output paths (not shown) with respective blocking (e.g., by at least one further lambda/4 impedance transformer) of the unwanted bands.

In some embodiments, FIG. 5, the frequency band separator 130a may comprise coupling elements 137-1, 137-2, for example comprising at least one capacitor each, for coupling one terminal of the respective impedance transformer 136-1, 136-2 to an electric reference potential, e.g. a ground potential. As an example, for signal frequencies of the second frequency band fb-2, the impedance transformer 136-1 comprises a comparatively large impedance, thus preventing the signal frequencies of the second frequency band fb-2 from propagating to the first output 134-1. Similarly, for signal frequencies of the first frequency band fb-1, the impedance transformer 136-2 comprises a comparatively large impedance, thus preventing the signal frequencies of the first frequency band fb-1 from propagating to the second output 134-2.

In some embodiments, at least one switch (not shown) may be added to the coupling elements 137-1, 137-2, e.g. configured to activate or deactivate frequency selective coupling. In some embodiments, such a configuration may e.g. be used if more frequency bands are to be, e.g. flexibly (e.g., under control of a respective switch), blocked.

FIG. 6A schematically depicts a frequency spectrum, in arbitrary units, of an exemplary multiband RF signal, as can e.g. be processed using the primary signal processing stage 110 according to the embodiments.

FIG. 6B schematically depicts a respective frequency spectrum of the output signal portion osp-fb-1 (FIG. 5) associated with the first frequency band fb-1, and FIG. 6C schematically depicts a respective frequency spectrum of the output signal portion osp-fb-2 (FIG. 5) associated with the second frequency band fb-2.

In some embodiments, FIG. 9A, at least one of the first secondary signal processing stage 140-1 (FIG. 4) and the second secondary signal processing stage 140-2 comprises at least one frequency band-specific amplifier 146, for example power amplifier, configured to amplify a signal associated with the first frequency band or the second frequency band. In some embodiments, as depicted by the exemplary configuration 140a of FIG. 9A, the secondary signal processing stage comprises an input 142 or first port P1, and an output 144 or second port P2.

In some embodiments, an optional bias circuit 146a may be provided for the frequency band-specific amplifier 146, e.g. for a) providing a bias to the frequency band-specific amplifier 146, e.g. based on a signal being processed by the secondary signal processing stage or the apparatus 100, e.g. to optimize an operation and/or performance of the frequency band-specific amplifier 146, and/or for b) turning on and/or turning off the frequency band-specific amplifier 146.

In some embodiments, an optional filter, for example band-pass filter, 147, 160 may be provided, a passband of which e.g. corresponds with the respective frequency band to be processed by the secondary signal processing stage 140a.

In some embodiments, the optional filter 147, 160 may be an antenna filter. In some embodiments, the antenna filter 160 may e. g. be placed after an optional circulator 149 (not shown in FIG. 9A, see, for example, FIG. 9E) and before an antenna ANT (FIG. 9E).

In some embodiments, FIG. 9B, at least one of the first secondary signal processing stage and the second secondary signal processing stage comprises a bypass 148, see the exemplary configuration 140b of FIG. 9B, for selectively bypassing the at least one frequency band-specific amplifier 146. In some embodiments, this way, e.g. a power amplification may selectively be activated or deactivated, e.g., by using the bypass 148 or the amplifier 146 for processing a signal provided at the input 142. In some embodiments, a related power amplifier may be turned off when bypassing is active (e.g., while it is bypassed), and may be turned-on when bypassing is disabled.

In some embodiments, FIG. 9C, at least one of the first secondary signal processing stage and the second secondary signal processing stage, see the exemplary configuration 140c of FIG. 9C, comprises a first switch 1481 and a second switch 1482, the first and second switches 1481, 1482 each having three ports 1481a, 1481b, 1481c and 1482a, 1482b, 1482c, and being configured to selectively couple the at least one frequency band-specific amplifier 146 or the bypass 148 to an input 142 and an output 144 of the at least one of the first secondary signal processing stage and the second secondary signal processing stage, as e.g. symbolized by the configuration 140c of FIG. 9C, thus e.g. controlling whether amplification using the frequency band-specific amplifier 146 is effected or whether an input signal to the secondary signal processing stage is bypassed with respect to, e.g. not amplified by, the frequency band-specific amplifier 146.

In some embodiments, FIG. 9D, at least one of the first secondary signal processing stage and the second secondary signal processing stage, see for example the configuration 140d of FIG. 9D, comprises a third switch 1483 (having three ports 1483a, 1483b, 1483c) configured to selectively couple a) a first port P1 (e.g. the input 142, also see FIG. 9A) of the at least one of the first secondary signal processing stage and the second secondary signal processing stage with a second port P2 (which may at least temporarily form a first output 144, see FIG. 9A) of the at least one of the first secondary signal processing stage and the second secondary signal processing stage or b) the second port P2 (which may at least temporarily form a second input) of the at least one of the first secondary signal processing stage and the second secondary signal processing stage with a third port P3 (e.g., a second output) of the at least one of the first secondary signal processing stage and the second secondary signal processing stage. In some embodiments, this way, different signal paths with respect to the secondary signal processing stages may be defined.

In other words, in some embodiments, a first signal path of the configuration 140d of FIG. 9D, which may e.g. be used for a transmit direction, may e.g. comprise the first port P1 as an input, and the second port P2 as an output. In some embodiments, a second signal path of the configuration 140d of FIG. 9D, which may e.g. be used for a receive direction, may e.g. comprise the second port P2 as an input, and the third port P3 as an output.

In some embodiments, the switch 1483 may be replaced by a circulator.

In some embodiments, see the configuration 140e of FIG. 9E symbolizing an exemplary secondary signal processing stage, the apparatus further comprises at least one circulator 149 configured to perform at least one of: a) providing a signal processed by at least one of the first secondary signal processing stage and the second secondary signal processing stage to at least one antenna ANT, b) providing a signal received from at least one antenna ANT to the primary signal processing stage 110 (FIG. 3A).

As an example, a signal amplified by the power amplifier 146 may e.g. provided to a first port 149-1 of the circulator 149, which forwards the signal to its second port 149-2, e.g. for output to the antenna ANT, whereas a signal received from the antenna ANT and input to the second port 149-2 of the circulator 149 is forwarded to the third port 149-3 of the circulator, and may e.g. be output via the third port P3, e.g. as a first signal s1.

In some embodiments, FIG. 9E, the at least one circulator 149 may e.g. be integrated in at least one secondary signal processing stage 140-1, 140-2, 140e.

In some embodiments, the at least one circulator 149 may e.g. be arranged outside of the at least one secondary signal processing stage.

In some embodiments, FIG. 9E, the at least one circulator 149 may e.g. be used to provide a signal s1 received from at least one antenna ANT to the second input 118-2 (FIG. 3A) of the primary signal processing stage 110, e.g. for processing the signal s1 received from at least one antenna ANT using the primary signal processing stage 110.

In some embodiments, FIG. 9E, the apparatus comprises at least one combiner 150 for combining a first signal s1 associated with the first frequency band fb-1 (e.g., received from the antenna ANT) and a second signal s2 associated with the second frequency band fb-2 (e.g., received from another antenna (not shown)) to a multiband signal mb-f1-f2, e.g. similar to the signal RFS-mb of FIG. 1. In some embodiments, the at least one combiner 150 may e.g. be used to combine different signals s1, s2 associated with different frequency bands fb-1, fb-2, e.g. received from one or more antennas ANT, e.g. to form a multiband signal mb-f1-f2, e.g. for processing of the so formed multiband signal mb-f1-f2, e.g. by the primary signal processing stage 110.

In some embodiments, FIG. 1, the apparatus 100 comprises at least one filter (e.g., antenna filter) 160 for filtering at least one signal associated with a single one of the first frequency band fb-1 and the second frequency band fb-2, e.g. at least one band-pass filter associated with the respective frequency band.

In some embodiments, FIG. 9A, the at least one filter 147, 160, e.g. band-pass filter, may e.g. be provided within at least one of the secondary signal processing stages 140a.

In some embodiments, FIG. 1, the at least one filter, e.g. band-pass filter, 160 may e.g. be provided outside of at least one of the secondary signal processing stages 140-1, 140-2.

In some embodiments, FIG. 1, the apparatus 100 comprises at least one phase shifter 170 for modifying a phase of at least one signal associated with the apparatus 100.

In some embodiments, the at least one phase shifter 170 may e.g. be provided in the primary signal processing stage 110.

In some embodiments, the at least one phase shifter 170 may e.g. be provided in at least one of the secondary signal processing stages 140-1, 140-2.

In some embodiments, FIG. 9E, the at least one phase shifter 170 (not shown in FIG. 9E) may e.g. be provided for at least one individual frequency band and/or antenna element of the antenna ANT, e.g. between the second port P2 and the filter 160.

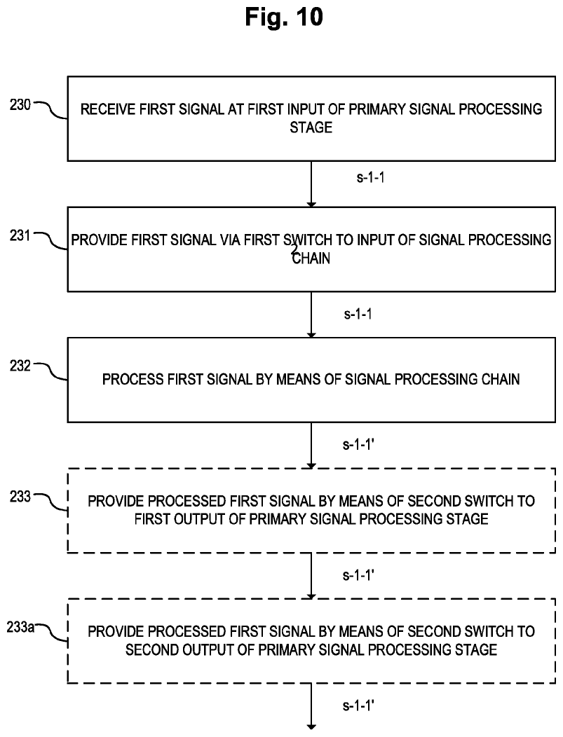

In some embodiments, FIG. 10, the apparatus 100 (FIG. 1) is configured to: receive 230 (FIG. 10) a first signal s-1-1 at the first input 118-1 (FIG. 3A) of the primary signal processing stage 110, provide 231 (FIG. 10) the first signal s-1-1 via the first switch 114 to the input 112c of the signal processing chain 112, process 232 the first signal s-1-1 by means of the signal processing chain 112, provide 233, 233a a processed first signal s-1-1′ via the second switch 116 either a) to the first output 119-1 of the primary signal processing stage 110 (thus e.g. defining a first mode of operation, e.g. associated with a transmit direction) or b) to the second output 119-2 of the primary signal processing stage 110 (thus e.g. defining a second mode of operation, e.g. a feedback mode, which e.g. enables to perform an analysis, e.g. of signal distortion as imparted on a signal processed by the signal processing chain 112). In some embodiments, the feedback mode may e.g. be used to apply a predistortion to a signal to be processed by the signal processing chain 112.

In some embodiments, the second mode or feedback mode may e.g. be used to linearize or optimize a performance of the primary signal processing stage 110. In some embodiments, e.g. in case of a multi-antenna system or other systems e.g. having more than one primary signal processing stage, some antenna elements/paths may be turned off or may be used for the feedback mode, e.g. for test measurements (e.g., self-test, performance optimization, sub-unit calibration), while some other antenna elements/paths may be used (e.g., simultaneously), e.g. for data transmission and/or reception.

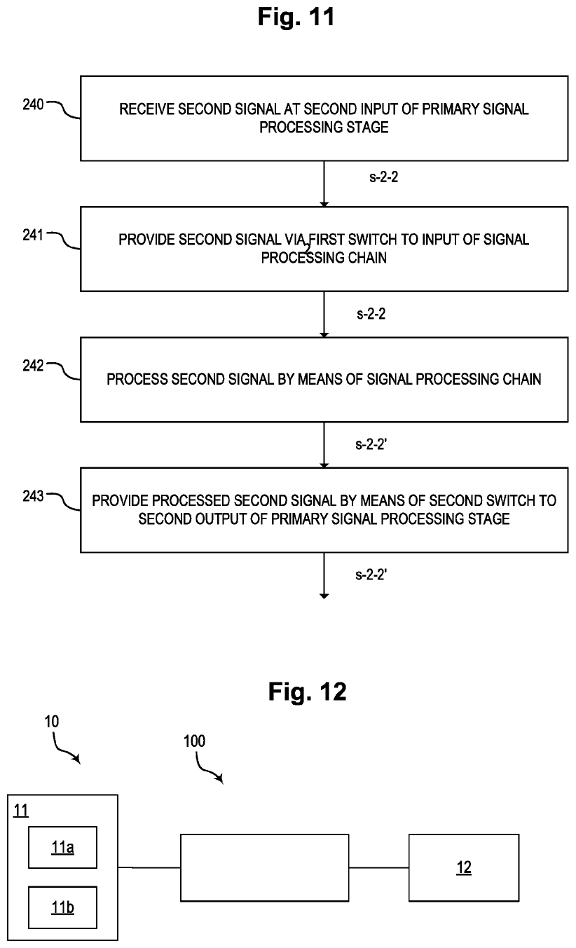

In some embodiments, FIG. 11, the apparatus 100 is configured to: receive 240 a second signal s-2-2 at the second input 118-2 of the primary signal processing stage 110, provide 241 the second signal s-2-2 via the first switch 114 to the input 112c of the signal processing chain 112, process 242 the second signal s-2-2 by means of the signal processing chain 112, provide 243 a processed second signal s-2-2′ via the second switch 116 to the second output 119-2 of the primary signal processing stage 110, (thus e.g. defining a third mode of operation, e.g. associated with a receive direction).

Further exemplary embodiments, FIG. 12, relate to a transceiver device 10 comprising at least one apparatus 100 according to the embodiments.

In some embodiments, the transceiver device 10 may comprise a signal source 11a providing at least one multiband RF signal RFS-mb comprising at least the first frequency band fb-1 and the second frequency band fb-2, e.g. for processing by the apparatus 100 according to the embodiments, e.g. in a transmit direction.

In some embodiments, the transceiver device 10 may comprise a signal sink 11b receiving at least one multiband RF signal processed by the apparatus 100 according to the embodiments, e.g. in a receive direction.

In some embodiments, the transceiver device 10 may comprise at least one antenna or antenna system 12, the antenna system 12 e.g. comprising multiple antenna elements.

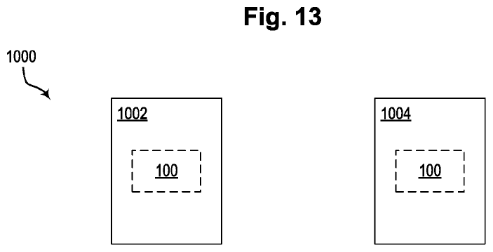

Further exemplary embodiments, FIG. 13, relate to a device 1002, 1004 for a wireless communications network 1000, e.g. according to the 5G and/or 6G type or of other types, comprising at least one apparatus 100 according to the embodiments.

In some embodiments, the device 1002 may e.g. be a network device, e.g. base station, e.g. gNB, for a cellular communications network.

In some embodiments, the device 1004 may e.g. be a terminal device, e.g. user equipment, for a cellular communications network.

Further exemplary embodiments relate to a wireless communication system 1000, e.g. network, comprising at least one device 1002, 1004 according to the embodiments.

Further exemplary embodiments, FIG. 2, relate to a method of processing radio frequency signals associated with an apparatus 100, the apparatus 100 comprising a primary signal processing stage 110 that is configured to process multiband radio frequency signals RFS-mb comprising at least a first frequency band fb-1 and a second frequency band fb-2, a first signal path 120-1, and a second signal path 120-2, wherein the method comprises: selectively coupling 200 the primary signal processing stage 110 a) with the first signal path 120-1 to enable processing of multiband radio frequency signals associated with the first signal path 120-1 using the primary signal processing stage 110 and/or b) with the second signal path 120-2 to enable processing of multiband radio frequency signals associated with the second signal path 120-2 using the primary signal processing stage 110.

Further embodiments, FIG. 2, relate to a computer program PRG or computer program product comprising instructions which, when the program is executed by a computer COMP, cause the computer COMP to carry out the method according to the embodiments.

In the following, further exemplary embodiments and aspects according to further exemplary embodiments are disclosed, which, in further exemplary embodiments, may be combined with any of the aforementioned embodiments.

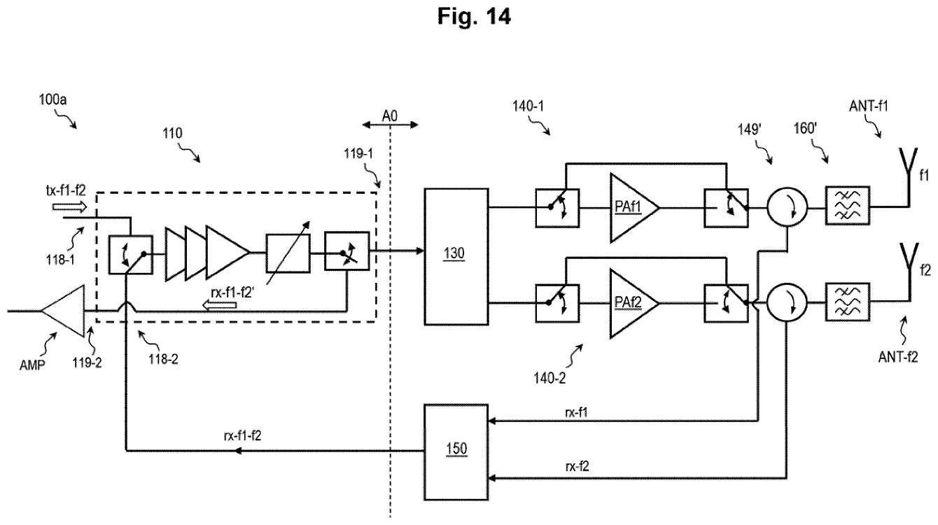

FIG. 14 schematically depicts a simplified block diagram of an apparatus 100a according to further embodiments. In the exemplary embodiment 100a of FIG. 14, two secondary signal processing stages 140-1, 140-2 are depicted, which exemplarily comprise a configuration similar to FIG. 9B, e.g. with one frequency-band specific power amplifier PAf1, PAf2 and a respective bypass.

In a first or transmit mode, multiband transmit signals tx-f1-f2 may be provided to the first input 118-1 of the primary signal processing stage 110, for processing, frequency band separation by element 130, optional frequency-band-individual power amplification by elements 140-1, 140-2 and output, via the circulators 149′, and with optional filtering by band-bass filters 160′, to respective antennas ANT-f1, ANT-12 associated with the respective frequency band fb-1, fb-2.

In some embodiments, the multiband transmit signals tx-f1-f2 may be provided by an up-conversion unit (e.g., mixer, modulator, or RF digital-to-analog converter) (not shown).

In a second or receive mode, respective single-band (e.g., filtered) receive signals rx-f1, rx-f2 obtained from the antennas ANT-f1, ANT-f2 via the circulators 149′ are combined by element 150, and a so obtained multiband receive signal rx-f1-f2 is provided to the second input 118-2 of the primary signal processing stage 110, for processing and output as signal rx-f1-f2′ via the second output 119-2. An optional further amplifier AMP (e.g., low noise amplifier) can be used to amplify the signal rx-f1-f2′. In some embodiments, the signal rx-f1-f2′ may be provided to a downconversion stage (not shown).

In some embodiments, the transmit mode and the receive mode may e.g. be executed in a TDD fashion, thus efficiently using the primary signal processing stage 110 for both the transmit mode and the receive mode.

The arrow A0 of FIG. 14 indicates that in some embodiments, the components 110, 130 may also be arranged spatially separated, e.g. arranged remotely, from each other, e.g. for providing spatially distributed antenna unit(s) or radio head(s).

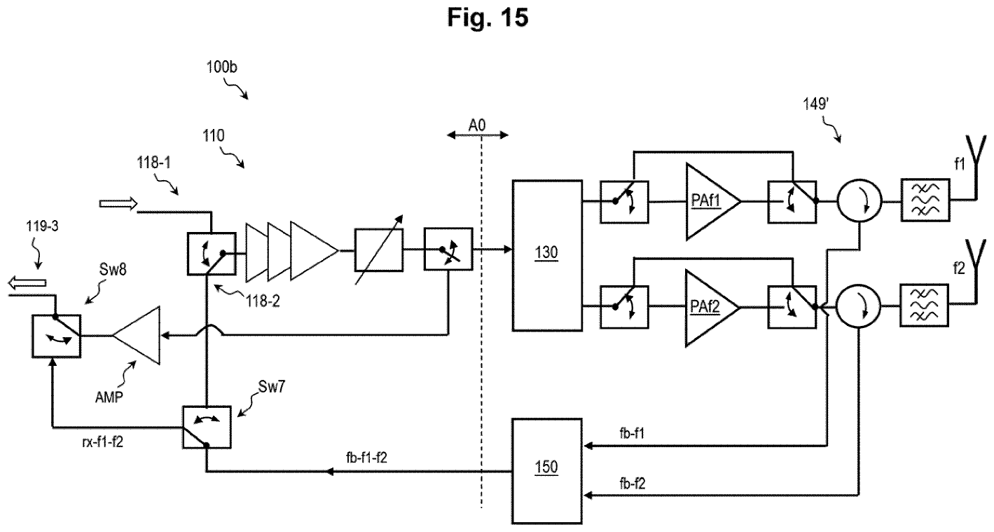

FIG. 15 schematically depicts a simplified block diagram of an apparatus 100b according to further embodiments, which is similar to apparatus 100a of FIG. 14. Apparatus 100b of FIG. 15, however, comprises additional switches Sw7, Sw8, which enable to selectively provide the multiband receive signal rx-f1-f2 either to the second input 118-2 of the primary signal processing stage 110 (as explained above with respect to FIG. 14), or to a further output 119-3 thus bypassing processing by the primary signal processing stage 110 and the further amplifier AMP.

In some embodiments, using the switches Sw7, Sw8, a feedback functionality can be achieved, e.g. during transmit mode, to e.g. support adaptive linearization (e.g. digital predistortion). When providing a transmit signal via the first input 118-1 to the primary signal processing stage, signals derived therefrom by the secondary signal processing stages 140-2, 140-2 may couple back via the circulators 149′ as feedback signals fb-f1, fb-f2 to the combiner and the switches Sw7, Sw8, where they may directly be output as a combined feedback signal fb-r1-f2, e.g. to the third output 119-3, e.g. to a down-conversion unit, e.g. to be further analyzed, e.g. for linearization purpose.

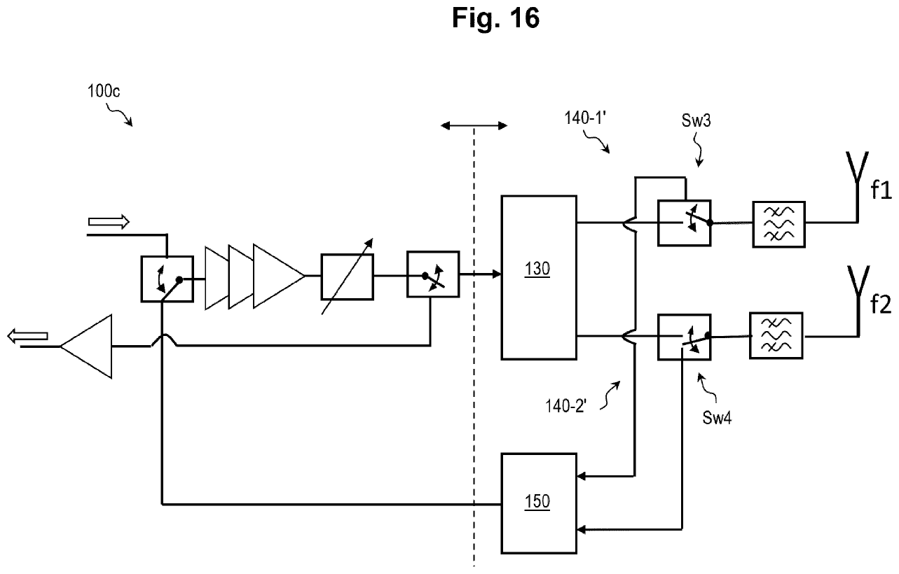

FIG. 16 schematically depicts a simplified block diagram of an apparatus 100c according to further embodiments, which may e.g. be used as a low to medium power multiband common transmit and receive apparatus. In difference to FIG. 14, 15, the apparatus 100c of FIG. 16 does not comprise power amplifiers in its secondary signal processing stages 140-1′, 140-2′, but rather, e.g. only, one switch per secondary signal processing stage, e.g. similar to the configuration 140d of FIG. 9D. In some embodiments, this variant 100c may e.g. address user equipment, UE, applications and/or multi-antenna applications with a comparatively large number of antennas or antenna elements, e.g. requiring less transmit power per antenna. In some embodiments, instead if the switches, circulators may be used in at least one of the secondary signal processing stages 140-1′, 140-2′. In some embodiments, additional switches Sw7, Sw8, see FIG. 15, may be used for the configuration 100c of FIG. 16, e.g. for enabling linearization, e.g. adaptive linearization.

In some embodiments, e.g. compared to medium to high power versions according to some embodiments, see for example FIG. 14, 15, in the apparatus 100c of FIG. 16 the power amplifiers and the optional bypassing network/switches may be skipped, e.g. due to lower required output power levels, e.g. per transmit path. While in FIG. 16, switches Sw3, Sw4 are exemplarily depicted, in some embodiments, circulators may alternatively be used, which in some embodiments may e.g. be recommended, e.g. in case an extension to support a feedback functionality is desired (see explanation for the feedback path of FIG. 15 above).

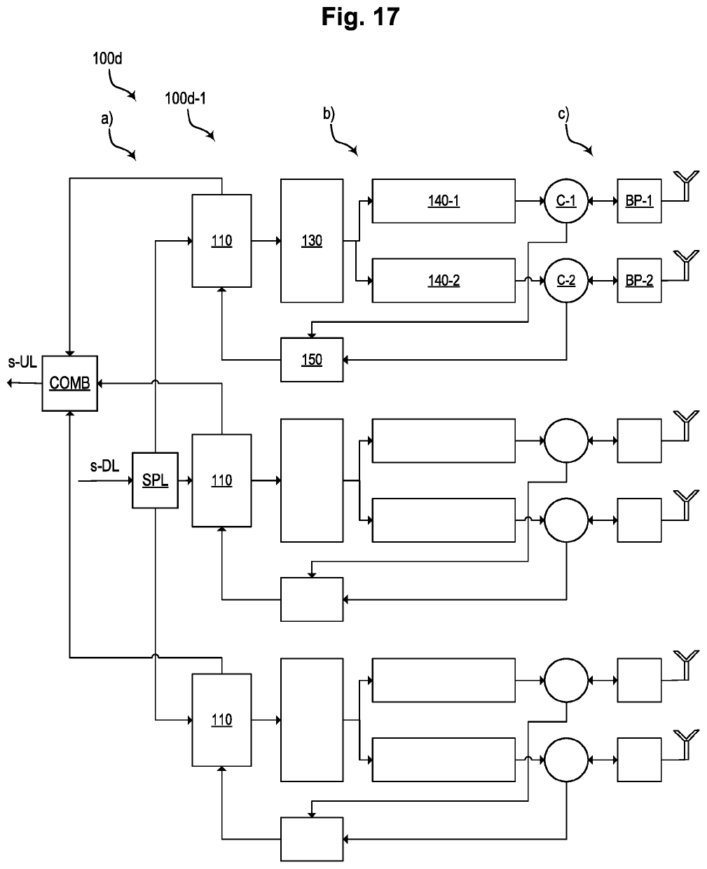

FIG. 17 schematically depicts a simplified block diagram of an apparatus 100d according to further embodiments. The apparatus 100d comprises three groups of signal processing components, only the first of which is denoted with reference sign 100d-1 for the sake of clarity. The further two groups comprise a structure identical or at least similar to group 100d-1. In some embodiments, the group 100d-1 may e.g. comprise a structure similar or identical to apparatus 100a of FIG. 14 or apparatus 100b of FIG. 15 or, for the present example, apparatus 100c of FIG. 16.

In some embodiments, an additional switch, e.g. a multi-pole switch, may be provided to connect the respective feedback paths, e.g. to allow to select a single one of the respective feedback paths to be measured at a point in time, e.g. to get feedback data for the respective antenna path. In some embodiments, determination of the feedback data may e.g. be done step-wise, e.g. by measuring step-by-step all the antennas (e.g., one feedback path after another), e.g. to get feedback data related to some, for example all, antenna paths, e.g. for linearization.

In some embodiments, a splitter SPL receives a transmit signal s-DL, e.g. for a downlink transmission(s), and power splits the transmit signal s-DL into three signal portions provided to a respective first input of the primary signal processing stage 110 of each of the groups 100d-1, . . . .

In some embodiments, a combiner COMP receives three receive signals from the groups 100d-1, . . . and combines them to a single receive signal s-UL, e.g. associated with uplink transmission(s).

In some embodiments, the splitter SPL and the combiner COMB may together characterize a port or MIMO (multiple input multiple output) layer of the apparatus 100d. In some embodiments, several ports or MIMO layers (not shown) may be provided.

The apparatus 100d of FIG. 17 can e.g. be used to transmit and/or receive RF multiband signals with a hybrid multi-antenna architecture.

In some embodiments, a further multi-antenna implementation variant may e.g. comprise or represent a, for example fully, digital multi-antenna system, which means that for each multiband antenna a full transceiver path, e.g. comprising a respective conversion unit and an apparatus 100 according to the embodiments, which, in some embodiments, means that a number of ports/layers may be equal to a number of multiband (f1+f2) antennas.

In some embodiments, by implementation of the splitter SPL (e.g., for downlink) and the combiner COMB (e.g. for uplink) per port, several antenna elements and, for example, multiband common transmit/receive paths may e.g. be controlled by a common conversion path (e.g. for upconversion and/or downconversion) associated with a respective port.

In some embodiments, e.g. in order to enable beamforming for the individual transmit and receive paths, and related antennas, analog beamforming elements (e.g. comprising at least one of a) phase shifter, b) variable controlled gain amplifier) can be implemented. In some embodiments, this can e.g. be done at different positions a), b), c) in the configuration as depicted by FIG. 17, marking different implementation variants.

In some embodiments, an amplitude control may e.g. be effected by at least one signal processing component of the primary signal processing stage 110.

In some embodiments, FIG. 17, position a) symbolizes providing phase shifter(s) for analog beamforming in a common transmit/receive path as e.g. realized by the primary signal processing stage 110. In some embodiments, this may have at least some of the following advantages: + no losses after power amplifier(s), thus e.g. beneficial for energy efficiency, + in order to also not impact receive sensitivity, the phase shifter may e.g. be provided between a first and a second amplifier stage of the primary signal processing stage 110, + individual (f1+f2) phase shift per antenna element, frequency bands fb-1 and fb-2 are commonly shifted. In some embodiments, a main benefit is: one common phase shifter may be provided for transmit and receive directions and both frequency bands fb-1, fb-2→comparatively low number of phase shifters is required→cost benefit.

In some embodiments, position b) symbolizes providing phase shifter(s) for analog beamforming for each antenna element, e.g. before an optional switch or circulator at an output of a respective secondary signal processing stage 140-1, 140-2. In some embodiments, this may have at least some of the following advantages: + enables flexible individual phase shifts for both frequency bands fb-1, fb-2, e.g. independent from a digital front end, as well as + individual phase shift per antenna element, + gives, for example maximum, flexibility in phase shift per antenna element→individual phases per frequency band and per antenna element possible, ⋅ individual phase shifter for transmit direction and receive direction required

In some embodiments, position c) symbolizes providing individual phase shifter(s) for analog beamforming for each individual frequency band per antenna element, e.g. after a switch or circulator at an output of a respective secondary signal processing stage 140-1, 140-2. In some embodiments, this may have at least some of the following advantages: + enables flexible individual fb-1 and fb-2 phase shifts independent from digital front end as well as individual phase shift per antenna element, + common phase shifter for transmit direction and receive direction, + gives, for example maximum, flexibility in phase shift per antenna element→individual phases per frequency band and per antenna element possible.

In some embodiments, using the principle according to the embodiments enables to attain savings on phase shifters, e.g. for hybrid multi-antenna systems. As an example, considering a hybrid multi-antenna system with 64 antenna elements, 16 conversion units (e.g., for frequency upconversion and/or downconversion) and two non-contiguous frequency bands fb-1, fb-2 to be covered, some conventional approaches employ up to 256 phase shifters, whereas exemplary embodiments may e.g. employ 64, 128 or 256 phase shifters, e.g. depending on the respective position for the phase shifters, see the abovementioned examples for positions a), b), c). In other words, in some embodiments, substantial savings related to phase shifters and thus complexity and cost can be attained, e.g. as compared to some conventional approaches.

Similarly, due to the possibility of using the primary signal processing stage 110 for both a transmit direction and a receive direction, a reduced complexity and reduced number of RF multiband signal processing capable components can be attained.

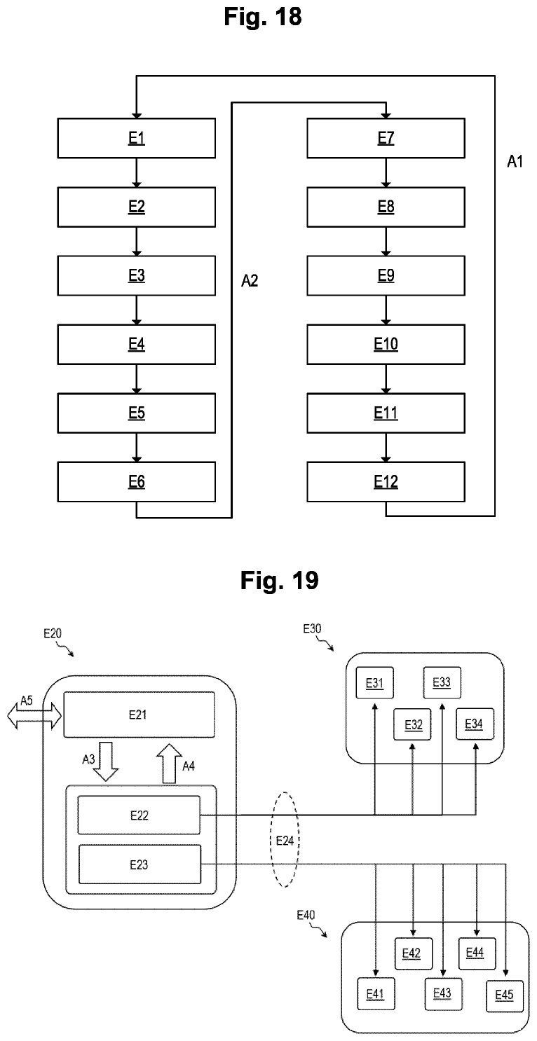

FIG. 18 schematically depicts a simplified flow-chart according to further embodiments related to an exemplary method for uplink and downlink operation.

Elements E1 to E6 are associated with a downlink operation, and elements E7 to E12 are associated with an uplink operation.

Element E1 symbolizes an initiation of the downlink operation, element E2 symbolizes setting the switches of the primary signal processing stage 110 (FIG. 3A), e.g. switches 114, 116, to a downlink operation mode (e.g., associated with a transmit direction). Element E3 of FIG. 18 symbolizes deactivating an optional uplink-specific amplifier, e.g. low noise amplifier (see for example element AMP of FIG. 14), e.g. to improve energy efficiency. Element E4 symbolizes activating optional power amplifiers which may e.g. provided in one or more secondary signal processing stages 140-1, 140-2, . . . , e.g. related to frequency bands to be operated. In some embodiments, power amplifiers for currently not operated frequency bands may be turned off or remain deactivated, for energy efficiency.

In some embodiments, at least one of the optional uplink-specific amplifiers may e.g. be used to provide sufficient output power, e.g. either to drive a linear drive, i.e. a final amplifier stage, or, e.g. in case a final (power) amplifier stage is bypassed, to provide sufficient transmit power, e.g. for a low load situation. In some embodiments, an optional attenuator may be configured to provide an adequate total line-up gain for a respective transmit operation.

Element E5 symbolizes configuring at least one further component of the apparatus according to the embodiments, e.g. at least one of: optional bias control device(s) 112a′ (FIG. 3A), 146a (FIG. 9A), bypass 148 (FIG. 9B). The configuring E5 may e.g. be done for optimizing an operation of e.g. the optional power amplifier(s) 146, e.g. with regard to energy efficiency based on a respective load situation. In some embodiments, e.g. in the case of bypassing a power amplifier 146, the bypassed power amplifier 146 may be turned off.

Element E6 symbolizes activating the downlink operation.

Element E7 symbolizes an initiation of the uplink operation, which may e.g. be performed in a TDD multiplexed manner with the downlink operation.

Element E8 symbolizes setting the switches of the primary signal processing stage 110 (FIG. 3A), e.g. switches 114, 116, to an uplink operation mode (e.g., associated with a receive direction). Element E9 of FIG. 18 symbolizes deactivating optional power amplifier(s) 146, e.g. to improve energy efficiency. Element E10 symbolizes configuring at least one further component of the apparatus according to the embodiments, e.g. at least one of: optional bias control device(s) 112a′ (FIG. 3A) (e.g., for the amplifier(s) 112a and/or other, for example common or frequency band-specific amplifiers, e.g. low noise amplifiers (not shown), e.g. for energy efficiency (and, e.g. in case of uplink operation, e.g. also for a noise figure and/or for an attenuator to be suitably configured for operation mode adapted gain)). Element E11 symbolizes activating the amplifier(s) 112a and potential further common or frequency band-specific amplifiers (not shown). Element E12 symbolizes activating the uplink operation.

Arrow A1 of FIG. 18 symbolizes a transition to the downlink operation, e.g. after the uplink operation, and arrow A2 of FIG. 18 symbolizes a transition to the uplink operation, e.g. after the downlink operation.

FIG. 19 schematically depicts a simplified block diagram according to some embodiments related to exemplary aspects of a potential control implementation, e.g. to configure and/or operate an apparatus 100 according to the embodiments.

Element E20 symbolizes aspects of a digital frontend, element E21 symbolizes a control related to at least one of: a) different modes of operation, e.g. transmit, receive (e.g., associated with a downlink direction or an uplink direction), b) frequency band-specific paths/components. Element E22 symbolizes a control associated with switches, e.g. mode select switches, e.g. to select transmit or receive mode, frequency selective components, etc., and element E23 symbolizes activation and/or deactivation of amplifier(s) 112, 146 of the apparatus 100 and, optionally, a bias control (e.g., including turning on and/or turning off), e.g. optimization, for at least one of the amplifier(s) 112, 146. Arrow A3 indicates a control action, and arrow A4 indicates status information.

Element E24 symbolizes one or more control interfaces, e.g. of the SPI (serial peripheral interface) type, for components or groups E30, E40 of components of an analog frontend. Group E30 symbolizes switches, e.g. first and second switches E31, e.g. similar to switches 114, 116 of FIG. 3A, for selecting a transmit or receive mode. Element E32 symbolizes switches for bypassing a power amplifier 146, e.g. for a first secondary signal processing stage 140-1, e.g. similar to switches 1481, 1482 of FIG. 9C. Element E33 symbolizes switches for selecting a feedback mode of operation or a regular receive mode, e.g. similar to switches Sw7, Sw8 of FIG. 15. Element E34 symbolizes switches for bypassing a power amplifier 146, e.g. for a second secondary signal processing stage 140-2, e.g. similar to switches 1481, 1482 of FIG. 9C.

Element E41 symbolizes an efficiency optimization for a power amplifier 146 (FIG. 9C) of a first secondary signal processing stage 140-1. Element E42 symbolizes an efficiency optimization for a power amplifier 146 (FIG. 9C) of a second secondary signal processing stage 140-2. Element E43 symbolizes an optimization for one or more amplifiers 112a of the primary signal processing stage 110, e.g. in a transmit mode in the sense of an efficiency optimization and/or an output power optimization (e.g. to drive a final amplifier stage 146 or, if a final amplifier stage is bypassed, to act as new “final” amplifier stage 112a for, e. g., low load situation), and in a receive mode in a sense of a combined efficiency and noise optimization. Element E44 symbolizes a combined efficiency and noise optimization of optional low noise amplifiers, e.g. for a receive mode. Element E45 symbolizes controlling a line-up gain, e.g. by an attenuator and/or variable gain amplifier, e.g. with respect to respective needs for uplink and/or downlink and/or full and/or low load situation.

The principle according to the embodiments can e.g. be used to provide transceiver devices capable of multiband RF signal processing, e.g. for use with hybrid multi-antenna systems.

According to further embodiments, the principle according to the embodiments can e.g. be used to provide other, for example, hybrid configurations and, for example, also an e.g. fully digital concept, wherein a number of conversion units is equal to a number of antennas (or number of multiband antenna pairs “f1+f2”), to which e.g. multiband common transmit/receive concept variants according to some embodiments can be applied as well.

Using the principle according to the embodiments, a large variety of combination of different multiband common transmitter/receiver variants (e.g. low power, high power, with or without feedback path, with or without power amplifier bypassing, etc.) to single-/low number transmit/receive applications and/or multi-antenna application is conceivable according to further embodiments, which e.g. allows to make a selection based on what meets, for example future, application requirements best.

In some embodiments, the principle according to the embodiments enables to provide flexible, compact and energy efficient multiband capable analog RF transceivers, e.g. supporting non-contiguous frequency band coverage.

In some embodiments, the primary signal processing stage 110 (FIG. 3A) represents a signal processing path which may be commonly used, e.g. in a TDD-based manner, for multiband signal processing both in a transmit, e.g. downlink, direction and a receive, e.g. uplink, direction (“common UL & DL TRX path”), the signal processing e.g. comprising amplification and/or attenuation and/or phase shifting.

In some embodiments, see for example FIG. 14, alternative to the dedicated frequency specific antennas ANT-f1, ANT-f2, the output signals of the two secondary signal processing stages 140-1, 140-2 may also be combined again (not shown), e.g. after the circulators 149′ (or after optional antenna filters), and may e.g. be fed to a common multiband or wideband antenna (not shown).

As mentioned above, in some embodiments, the principle according to the embodiments may e.g. be used to provide multiband (e.g., even with non-contiguous frequency bands fb-1, fb-2)-capable analog RF transceivers, e.g. for single multiband TRX applications as well as for multi-antenna systems (e.g., with fully digital as well as hybrid architectures).

In some embodiments, the principle according to the embodiments is applicable from a sub 6 GHz, mm-wave frequency range up to sub-THz and THz frequency range.

In some embodiments, the principle according to the embodiments may e.g. be used for 5G and future 6G mobile radio multiband applications, enabling to provide more compact, less costly and more flexible and sustainable analogue RF transceivers, e.g. reducing design effort and frequency band related plurality of analogue TRX solutions.

In some embodiments, the principle according to the embodiments is applicable to both, base station applications as well as user equipment. In some embodiments, other fields of application are also possible, e.g. not related to cellular communications systems, such as e.g. point-to-point communication, communication for IoT devices, and the like. In some embodiments, the principle according to the embodiments enables to provide apparatus 100 capable to support several e.g. non-contiguous frequency bands fb-1, fb-2, e.g. distributed over a wide frequency range, e.g. comprising a compact and flexible design, e.g. with reduced design effort and cost while still maintaining high energy efficiency and improving sustainability.

In some embodiments, the principle according to the embodiments, by applying the frequency band separator 130, enables to reduce a power loss, e.g. compared to power splitting devices, and even a filtering/suppression of the unwanted signal (i.e., another frequency band) can be achieved, which leads to lower unwanted signal levels e.g. at power amplifiers 146 of subsequent secondary signal processing stages 140-1, 140-2, and which in result also supports energy efficiency.

In some embodiments, the principle according to the embodiments is applicable to single TRX applications as well as to multi-antenna applications (e.g., fully digital or hybrid, mMIMO (massive MIMO) or beamforming).

In some embodiments, the principle according to the embodiments is flexible with respect to if e.g. both (all) frequency bands fb-1, fb-2 are operated at the same time, or if e.g. for a certain point in time only one of the frequency bands (or in case of more than two bands e.g. some bands are active, while others are deactivated) is active while the other one is deactivated. Also, some embodiments allow to optimize e.g. an RF frontend to such varying mode of operations, e.g. by adequate amplifier, attenuator, switches, etc. configuration.

Further embodiments relate to an apparatus for processing radio frequency signals, the apparatus comprising means for processing multiband radio frequency signals comprising at least a first frequency fb-1 band and a second frequency band fb-2, a first signal path 120-1, and a second signal path 120-1, wherein the apparatus further comprises: means for selectively coupling a primary signal processing stage 110 configured to process the multiband radio frequency signals a) with the first signal path 120-1 to enable processing of multiband radio frequency signals associated with the first signal path 120-1 using the primary signal processing stage 110 and/or b) with the second signal path 120-2 to enable processing of multiband radio frequency signals associated with the second signal path 120-2 using the primary signal processing stage 110.

1. An apparatus for processing radio frequency signals, comprising a primary signal processing stage that is configured to process multiband radio frequency signals comprising at least a first frequency band and a second frequency band, a first signal path, and a second signal path, wherein the apparatus is configured to selectively couple the primary signal processing stage a) with the first signal path to enable processing of multiband radio frequency signals associated with the first signal path using the primary signal processing stage and/or b) with the second signal path to enable processing of multiband radio frequency signals associated with the second signal path using the primary signal processing stage.

2. The apparatus according to claim 1, wherein the first frequency band and the second frequency band are non-contiguous.

3. The apparatus according to claim 1, wherein the primary signal processing stage comprises a signal processing chain comprising at least one signal processing element capable of processing the multiband radio frequency signals, a first switch and a second switch, wherein the first switch is configured to selectively couple a first input of the primary signal processing stage or a second input of the primary signal processing stage to an input of the signal processing chain, wherein the second switch is configured to selectively couple an output of the signal processing chain to a first output of the primary signal processing stage or to a second output of the primary signal processing stage.

4. The apparatus according to claim 3, wherein the at least one signal processing element comprises at least one of a) an amplifier, b) an attenuator a bias control device for applying a predetermined bias to at least one amplifier.

5. The apparatus according to claim 1, comprising a frequency band separator configured to receive an output signal of the primary signal processing stage comprising a first output signal portion associated with the first frequency band and a second output signal portion associated with the second frequency band, to provide the first output signal portion to a first secondary signal processing stage, and to provide the second output signal portion to a second secondary signal processing stage.

6. The apparatus according to claim 5, wherein the frequency band separator comprises a first impedance transformer associated with a wavelength of the second frequency band and a second impedance transformer associated with a wavelength of the first frequency band.

7. The apparatus according to claim 5, wherein at least one of the first secondary signal processing stage and the second secondary signal processing stage comprises at least one frequency band-specific amplifier configured to amplify a signal associated with the first frequency band or the second frequency band.

8. The apparatus according to claim 7, wherein at least one of the first secondary signal processing stage and the second secondary signal processing stage comprises a bypass for selectively bypassing the at least one frequency band-specific amplifier.

9. The apparatus according to claim 8, wherein at least one of the first secondary signal processing stage and the second secondary signal processing stage comprises a first switch and a second switch, the first and second switches configured to selectively couple the at least one frequency band-specific amplifier or the bypass to an input and an output of the at least one of the first secondary signal processing stage and the second secondary signal processing stage.

10. The apparatus according to claim 5, wherein at least one of the first secondary signal processing stage and the second secondary signal processing stage comprises a third switch configured to selectively couple a) a first port of the at least one of the first secondary signal processing stage and the second secondary signal processing stage with a second port of the at least one of the first secondary signal processing stage and the second secondary signal processing stage or b) the second port of the at least one of the first secondary signal processing stage and the second secondary signal processing stage with a third port of the at least one of the first secondary signal processing stage and the second secondary signal processing stage.

11. The apparatus according to claim 5, further comprising at least one circulator configured to perform at least one of: a) providing a signal processed by at least one of the first secondary signal processing stage and the second secondary signal processing stage to at least one antenna, b) providing a signal received from at least one antenna to the primary signal processing stage.

12. The apparatus according to claim 1, comprising at least one combiner for combining a first signal associated with the first frequency band and a second signal associated with the second frequency band to a multiband signal.

13. The apparatus according to claim 1, comprising at least one filter for filtering at least one signal associated with a single one of the first frequency band the second frequency band.

14. The apparatus according to claim 1, comprising at least one phase shifter for modifying a phase of at least one signal associated with the apparatus.

15. The apparatus according to claim 3, wherein the apparatus is configured to: receive a first signal at the first input of the primary signal processing stage, provide the first signal via the first switch to the input of the signal processing chain, process the first signal by means of the signal processing chain, provide a processed first signal via the second switch either a) to the first output of the primary signal processing stage or b) to the second output of the primary signal processing stage.

16. The apparatus according to claim 3, wherein the apparatus is configured to: receive a second signal at the second input of the primary signal processing stage, provide the second signal via the first switch to the input of the signal processing chain, process the second signal by means of the signal processing chain, provide a processed second signal via the second switch to the second output of the primary signal processing stage.

17. A transceiver device comprising at least one apparatus according to any of the preceding claims claim 1.

18. A method of processing radio frequency signals associated with an apparatus, the apparatus comprising a primary signal processing stage that is configured to process multiband radio frequency signals comprising at least a first frequency band and a second frequency band, a first signal path, and a second signal path, wherein the method comprises: selectively coupling the primary signal processing stage a) with the first signal path to enable processing of multiband radio frequency signals associated with the first signal path using the primary signal processing stage or b) with the second signal path to enable processing of multiband radio frequency signals associated with the second signal path using the primary signal processing stage.

19. A base station comprising at least one apparatus according to claim 1.

20. A user equipment comprising at least one apparatus according to claim 1.
